(19) United States
(12) Patent Application Publication
(10) Pub. No.: US 2017/0034876 A1
(43) Pub. Date: Feb. 2, 2017

(54) MICROWAVE TREATMENT APPARATUS

(71) Applicant: PANASONIC CORPORATION, Kadoma-shi (JP)

(72) Inventors: YOSHIHARU OMORI, Shiga (JP); KOJI YOSHINO, Shiga (JP); HIROYUKI UNO, Ishikawa (JP); HIROYUKI UEJIMA, Ishikawa (JP)

(73) Assignee: Panasonic Corporation, Osaka (JP)

(21) Appl. No.: 15/114,141

(22) PCT Filed: Feb. 23, 2015
(86) PCT No.: PCT/JP2015/000841

§ 371 Date: Jul. 26, 2016

(30) Foreign Application Priority Data
Feb. 26, 2014 (JP) 2014-034990

(51) Int. Cl. H05B 6/70

(52) U.S. Cl. CPC H05B 6/707; H05B 6/705

(57) ABSTRACT

Microwave treatment apparatus (10) includes heating chamber (11) that accommodates object (7) to be heated, oscillation source (7) for oscillating microwave, and base (4) on which object (7) is placed in heating chamber (11), waveguide (6) for guiding the microwave below base (4), and cyclically structured unit (2) disposed in association with waveguide (6) for propagating the microwave in a surface-wave mode. Cyclically structured unit (2) has first region (2a) and second region (2b), and these two regions have impedances different from each other. The structure discussed above allows maintaining desirable characteristics of a surface waveguide proper to the waveguide that includes the cyclically structured unit.

### TECHNICAL FIELD

The present disclosure relates to a microwave treatment apparatus equipped with a surface waveguide employing a cyclically structured unit.

### BACKGROUND ART

It has been known that a conventional microwave treatment apparatus includes a waveguide equipped with a ladder circuit formed of a ridge section and a slot section (e.g. refer to patent literature 1). According to this conventional art, use of an electric field concentration caused by the ladder circuit allows applying a mark of a burn to an object and applying a dielectric heat to the object simultaneously.

Besides the foregoing conventional art, another microwave treatment apparatus that includes a heating plate formed of a cyclically structured unit is known. This apparatus guides microwaves from a waveguide via antenna to the heating plate, which is then excited by the microwaves (e.g. refer to patent literature 2). This conventional art allows changing a groove depth of the cyclically structured unit, and adjusting an intensity of surface-wave heating, thereby changing a heating distribution in height direction.

### CITATION LIST

Patent Literature 1: Unexamined Japanese Patent Application Publication No. S49-16944

Patent Literature 2: Unexamined Japanese Patent Application No. H05-66019

### SUMMARY OF THE INVENTION

It has been difficult for the conventional art discussed above to apply a desirable mark of a burn onto an object to be heated while concentrated heating to the object of various shapes, kinds, and amount is maintained.

According to the conventional art discussed above, the waveguide equipped with a ladder circuit, which is an example of the cyclically structured unit, can generate the surface wave, thereby concentrating the microwaves onto the object. However, the object accommodated in the apparatus affects and changes the characteristics of the surface waveguide, so that it has been difficult for the conventional art to apply concentrated heat to a desirable place.

The method disclosed in patent literature 1 cannot correct the characteristics, of the surface waveguide, affected by the object accommodated in the apparatus, so that the performance of the concentrated heating done by the surface wave is changed due to a type or an amount of the object. As a result, a desirable heating cannot be expected.

The method disclosed in patent literature 2 changes uniformly the groove depth of the cyclically structured unit, whereby an application of a mark of a burn onto the object surface can be switched to a dielectric heat inside the object. This method is thus not to correct the state affected by the object accommodated in the apparatus.

The present disclosure addresses the foregoing problem and aims to provide a microwave treatment apparatus that can correct the characteristics, affected by the object, of surface waveguide. This apparatus thus improves the performance of the concentrated heating done by the surface-wave.

To overcome the foregoing problem, a microwave treatment apparatus in accordance with one aspect of the present disclosure is formed of the following structural elements: a heating chamber that accommodates an object to be heated, an oscillation source for oscillating microwave, a base on which the object is placed in the heating chamber, a waveguide for guiding the microwave to below the base, and a cyclically structured unit disposed in association with the waveguide for propagating the microwave in a surface-wave mode.

The cyclically structured unit includes a first region and a second region, and their impedances are different from each other.

The microwave treatment apparatus of the present disclosure corrects the changes in the characteristics, affected by the object, of the surface waveguide, thereby maintaining desirable characteristics of the surface waveguide. As a result, an application of a desirable mark of a burn onto the object can be achieved.

### BRIEF DESCRIPTION OF DRAWINGS

FIG. 1 is a schematic sectional view illustrating a structure of a microwave treatment apparatus in accordance with a first embodiment of the present disclosure.

FIG. 2 is a perspective view illustrating a structure of a waveguide in accordance with the first embodiment.

FIG. 3 is a schematic sectional view illustrating a structure of a microwave treatment apparatus in accordance with a second embodiment of the present disclosure.

FIG. 4 is a schematic sectional view illustrating a structure of a microwave treatment apparatus in accordance with a third embodiment of the present disclosure.

FIG. 5 is a perspective view illustrating a structure of a waveguide in accordance with the third embodiment.

FIG. 6 is a perspective view illustrating a structure of a waveguide of a microwave treatment apparatus in accordance with a fourth embodiment of the present disclosure.

### DESCRIPTION OF EMBODIMENTS

The microwave treatment apparatus in accordance with the present disclosure is formed of the following structural elements: a heating chamber that accommodates an object to be heated, an oscillation source for oscillating microwave, a base on which the object is to be placed in the heating chamber, a waveguide for guiding the microwave to below the base, and a cyclically structured unit disposed in association with the waveguide for propagating the microwave in a surface-wave mode.

The cyclically structured unit includes a first region and a second region, and their impedances are different from each other.

The present disclosure allows correcting the changes in the characteristics, affected by the presence of the object, of the surface waveguide, thereby maintaining desirable characteristics of the surface waveguide. As a result, an application of a desirable mark of a burn onto the object can be achieved.

To be more specific, the cyclically structured unit is formed by arranging metal plates cyclically in the waveguide and disposing them in a vertical direction with respect to a propagating direction of the microwave. Here is one aspect of the present disclosure: the metal plates disposed in association with the first region have lengths different from those of the metal places disposed in association with the second region.

In the cyclically structured unit having the structure discussed above, an interval between any two metal plates associated with the first region can be different from an interval between any two metal plates associated with the second region.

Another aspect of the present disclosure shows that the cyclically structured unit is disposed in a part of the waveguide, and includes an interdigital structure in which fingers confront each other with a slit disposed in between and having a given width. A dielectric body is inserted into each one of the slits disposed in the first region.

The embodiments of the present disclosure are demonstrated hereinafter with reference to the accompanying drawings, in which elements similar to each other have the same reference marks, and the duplicated descriptions thereof are omitted.

### First Exemplary Embodiment

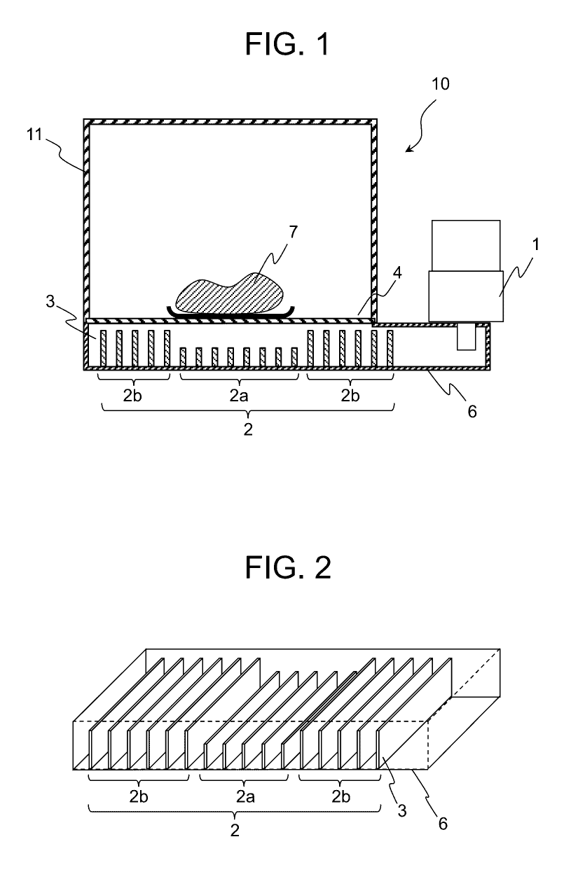

FIG. 1 is a schematic sectional view of microwave treatment apparatus 10 in accordance with the first embodiment of the present disclosure. FIG. 1 shows structures of waveguide 6 and heating chamber 11 among other structural elements. FIG. 2 is a perspective view showing a structure inside waveguide 6.

As FIG. 1 and FIG. 2 show, magnetron 1 is an oscillation source that oscillates microwaves. Waveguide 6 is disposed close to base 4 at a lower part of heating chamber 11, and extends from a place where magnetron 1 is mounted to as far as a place below heating chamber 11. An object to be heated is placed on base 4.

Cyclically structured unit 2 is disposed in association with waveguide 6 (in this embodiment, it is disposed within waveguide 6), and is formed of multiple metal plates 3 arranged cyclically, and yet disposed vertically with respect to the propagating direction of the microwave. The microwave propagates in waveguide 6 in the vicinity of the upper ends of metal plates 3 to as far as a place below heating chamber 11. The “arranged cyclically” refers to that multiple identical structural elements are placed at given intervals, namely, equidistantly.

An optimum design of length (height in this embodiment), interval, and the like of each one of metal plates 3 allows the microwave to become slow-wave within the range in which cyclically structured unit 2 is disposed, so that the microwave propagates within waveguide 6 in the surface wave mode. Since waveguide 6 is open on base 4 side, the microwave propagating through cyclically structured unit in the surface wave mode is supplied into heating chamber 11.

When object 7 is actually put on base 4 at around the center of base 4, the presence of object 7; however, causes changing an impedance of cyclically structured unit 2 at near object 7, thereby changing the characteristics of the surface waveguide in waveguide 6. This change causes disturbing the propagation of the microwave in the surface-wave mode.

To overcome this problem, this embodiment employs cyclically structured unit 2 of which metal plates 3 in first region 2a have lower heights than other metal plates 3 in second regions 2b. First region 2a is located below heating chamber 11 at around the center of chamber 11, and second regions 2b are the regions other than first region 2a.

In other words, metal plates 3 have a first length in first region 2a and have a second length different from the first length in second region 2b.

Use of the foregoing cyclically structured unit 2 allows adjusting the impedance of unit 2 near object 7, so that the characteristics of the surface waveguide can be corrected. As a result, the propagation of the microwave in the surface-wave mode can be maintained, and object 7 is irradiated with this microwave to be heated intensely. As a result, a desirable mark of a burn can be applied to the surface of object 7.

### Second Exemplary Embodiment

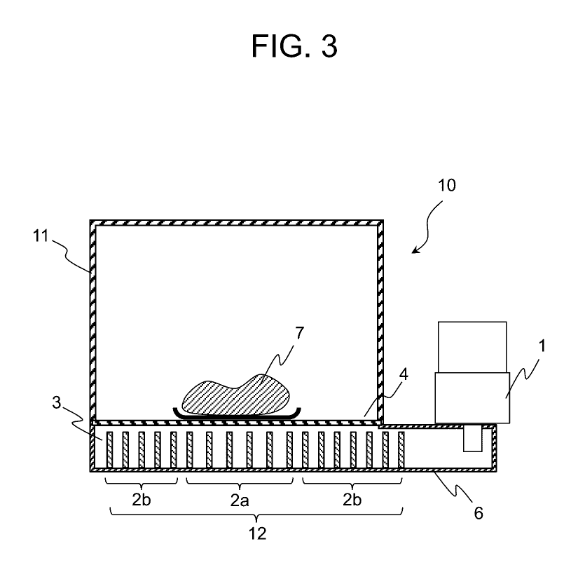

FIG. 3 is a schematic sectional view illustrating a structure of microwave treatment apparatus 10 in accordance with the second embodiment of the present disclosure. FIG. 3 shows the structure of waveguide 6 and heating chamber 11 among other structural elements.

Similar to the structure shown in the first embodiment, cyclical structured unit 12 is disposed in waveguide 6, and unit 12 is formed of multiple metal plates 3 arranged cyclically, and yet disposed vertically with respect to the propagating direction of the microwave.

This second embodiment differs from the first embodiment in the structure of cyclically structured unit 12 in that an interval between any two metal plates 3 in first region 2a is set greater than an interval between any two metal plates 3 in second regions 2b.

To be more specific, the intervals between two metal plates in first region 2a differ from the intervals between two metal plates in second regions 2b.

Cyclically structured unit 12 discussed above allows correcting the influence due to the presence of object 7, so that the propagation of the microwave in the surface-wave mode can be maintained, and a desirable mark of a burn can be applied onto the surface of object 7.

### Third Exemplary Embodiment

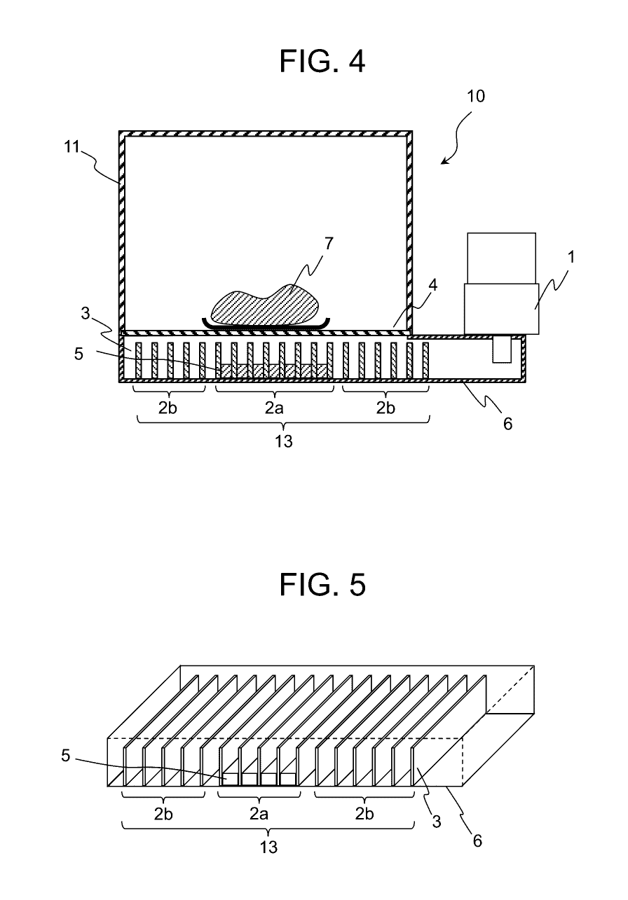

FIG. 4 is a schematic sectional view illustrating a structure of microwave treatment apparatus 10 in accordance with the third embodiment of the present disclosure. FIG. 4 shows the structure of waveguide 6 and heating chamber 11 among other structural elements. FIG. 5 is a perspective view of a structure inside waveguide 6 in accordance with the third embodiment.

Similar to the first and the second embodiments, cyclically structured unit 13 is disposed in waveguide 6, and unit 13 is formed of multiple metal plates 3 arranged cyclically, and yet disposed vertically with respect to the propagating direction of the microwave.

This third embodiment differs from the first and the second embodiments in the structure of cyclically structured unit 13 as shown in FIG. 4. Cyclically structured unit 13 is formed of multiple metal plates 3 arranged at intervals identical to each other, and impedance adjusting member 5 is inserted between any two metal plates 3 in first region 2a.

Impedance adjusting member 5 is made of dielectric material such as resin, and corrects the impedance in first region 2a of cyclically structured unit 13.

The foregoing cyclically structured unit 13 allows correcting the influence due to the presence of object 7, so that the propagation of the microwave in the surface-wave mode can be maintained, and a desirable mark of a burn can be applied onto the surface of object 7.

### Fourth Exemplary Embodiment

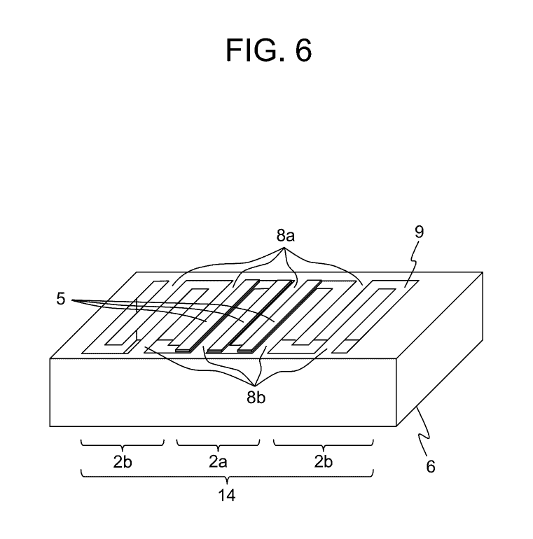

FIG. 6 is a perspective view illustrating a structure of microwave treatment apparatus 10 in accordance with the fourth embodiment of the present disclosure. FIG. 6 shows the structure of waveguide 6 among other structural elements.

As shown in FIG. 6, waveguide 6 includes slit 9 on its top face. Slit 9 meanders in a hook shape, and associates cyclically structured unit 14 with waveguide 6 (in this embodiment, unit 14 is disposed on a top face of waveguide 6).

Cyclically structured unit 14 is formed of metal slips 8a and 8b. These metal slips form an interdigital comb structure, and extend vertically with respect to the propagating direction of the microwave. In other words, cyclically structured unit 14 is in an interdigital structure.

In this fourth embodiment, impedance adjusting member 5 is inserted between any two slits 9 disposed in first region 2a. Impedance adjusting member 5 is formed of dielectric material such as resin.

The foregoing cyclically structured unit 14 allows correcting the influence due to the presence of object 7, so that the propagation of the microwave in the surface-wave mode can be maintained, and a desirable mark of a burn can be applied onto the surface of object 7.

### INDUSTRIAL APPLICABILITY

As discussed previously, the microwave treatment apparatus in accordance with the present disclosure can maintain the characteristics of the surface waveguide proper to the waveguide that includes the cyclically structured unit. The present disclosure is applicable not only to cooking heaters such as a microwave oven, but also to a wet-refuse disposer.

### REFERENCE MARKS IN THE DRAWINGS

1 magnetron
2, 12, 13, 14 cyclically structured unit
2a first region
2b second region
3 metal plate
4 base
5 impedance adjusting member
6 wave guide
7 object to be heated
8a, 8b metal slip
9 slit
10 microwave treatment apparatus
11 heating chamber

1. A microwave treatment apparatus comprising:
a heating chamber accommodating an object to be heated;
an oscillation source for oscillating a microwave;
a base on which the object is to be placed in the heating chamber;
a waveguide for guiding the microwave below the base; and
a cyclically structured unit disposed in association with the waveguide for propagating the microwave in a surface-wave mode,
wherein the cyclically structured unit has a first region and a second region, and an impedance of the first region is different from an impedance of the second region.

2. The microwave treatment apparatus according to claim 1, wherein the cyclically structured unit is formed of metal plates disposed vertically with respect to a propagating direction of the microwave, and the metal plates are placed cyclically in the waveguide,
wherein the metal plates placed in the first region have a length different from a length of the metal plates placed in the second region.

3. The microwave treatment apparatus according to claim 1, wherein the cyclically structured unit is formed of metal plates disposed vertically with respect to a propagating direction of the microwave, and the metal plates are placed cyclically in the waveguide,
wherein an interval between any two of the metal plates placed in the first region is different from an interval between any two of the metal plates placed in the second region.

4. The microwave treatment apparatus according to claim 1, wherein the cyclically structured unit is formed of metal plates disposed vertically with respect to a propagating direction of the microwave, and the metal plates are placed cyclically in the waveguide,
wherein a dielectric body is inserted into a space between any two of the metal plates placed in the first region.

5. The microwave treatment apparatus according to claim 1, wherein the cyclically structured unit has an interdigital structure disposed in a part of the waveguide.
